(19) United States
(12) Patent Application Publication
(10) Pub. No.: US 2010/0201122 A1
(43) Pub. Date: Aug. 12, 2010

(54) Fabrication Process to Connect Branch Air Ducts to Main Air Ducts and the Fabricated Ventilating Ducts

(76) Inventor: Liang Zhi, Zhejiang (CN)

Correspondence Address: GLOBAL IP SERVICES, 7285 W. Eagle Court, Winton, CA, 95388, US

(21) Appl. No.: 12/669,448

(22) PCT Filed: Jul. 14, 2008
(86) PCT No.: PCT/CN2008/001310

§ 371 Date: Jan. 15, 2010

(30) Foreign Application Priority Data
Jul. 16, 2007 (CN) 200710070028.2

(51) Int. Cl. F16L 41/08; B23P 11/00; E04F 17/04

(52) U.S. Cl. 285/189; 29/428

(57) ABSTRACT

A fabrication process to connect branch ventilating ducts to main ventilating ducts comprising: a, use non-combustible sandwich panels which are consisted by substrates on both sides and non-combustible material in middle to form a main air duct and a branch duct, both have rectangular cross-section; b, open on side panels of the main air duct birdsmouths (10) corresponding to a diameter of the branch air duct; c, attach a connector (21) on the branch duct to the birdsmouth (10). Therefore the manufactured air duct includes a connecting structure of a branch ventilating ducts with a main ventilating ducts, wherein in the main air duct (11) is located the birdsmouth (10) whose dimension is matching to the diameter of the branch air duct, and at the end of the branch air duct (22) is formed the connector (21).

### FIELD OF THE INVENTION

This invention relates to a fabrication process of ventilation ducts used in the construction sector and the products obtained, especially the process to connect branch ducts to main ducts and ventilation ducts obtained through this fabrication process.

### BACKGROUND OF THE INVENTION

The existing process to make ventilation ducts out of Chlorine oxide glass fiber reinforced cementitious materials (commonly known as inorganic glass fiber reinforced plastic ducts) is: use prefabricated wooden mold to shape the duct; apply a layer of magnesium oxychloride cement on the surface of the shaped duct and then glue a layer of glass cloth; Repeat the manual pasting operation to the set thickness; remove wooden molds as magnesium oxychloride cement cures off; thereby a duct is formed.

If it's required to connect a branch duct to a certain section of the main air duct, the common way is to use connecting flange, so while making the main air duct mold we should also make corresponding molds for connecting flanges; while manually pasting main ducts we should also paste connecting flanges for air ducts. The unified production of air ducts and connecting flanges makes sure that air ducts and connecting flanges produced are integrated.

This production method is complex and inefficient. Moreover, because the connecting flange and the main air duct are in a unified structure and have a one to one corresponding relationship, the relative position of the connecting flange to the main air duct cannot be changed. However, during the actual installation of air ducts, it often happens that the actual installation position of branch ducts doesn't conform to the original drawings, which causes the situation that the ventilation pipelines with branch ducts could not be installed. In this situation, we have to reproduce the whole structure, which is a waste of labor and material.

### SUMMARY OF THE INVENTION

The technical program and technical task of the invention to provide a fabrication process to connect branch ventilating ducts to main ventilating ducts and ventilating ducts obtained therefrom. This fabrication process makes it possible to open joints in accordance with the actual needs of the installation of ventilation ducts. Thanks to the above fabrication process the relative positions of the main duct and branch ducts can be changed according to actual installation requirements, which solves the problem caused by the mismatching of the designed position and the actual installation position existing in current technologies.

The technical scheme employed in this invention is as follows: a fabrication process to connect branch ventilating ducts to main ventilating ducts featured by its procedures: Step 1, use non-combustible sandwich panels which are consisted by substrates on both sides and non-combustible material in middle to form a main air duct and a branch duct both have rectangular cross-section; Step 2, open on side panels of the main air duct birdsmouth corresponding to a diameter of the branch air duct; Step 3, attach a connector on the branch duct to the birdsmouth. The joint is formed in the Inner cavity of the birdsmouth which can be opened on any side of the main air duct. The size of the birdsmouth depends on the dimension of the connector on the branch duct and can be maximized to adapt to the width of the panels on each side of the main duct. The branch duct can either be directly adhered to the outer surface of the main air duct at the joint section or be put into a connector and then adhered to the bonding plane of the birdsmouth. The assembling and splicing can wait till non-combustible sandwich panels are delivered to the construction site, which is conducive to saving space and cost of storage and transportation. When technical requirements are low, we can replace non-combustible panels with fire-retardant boards that are to use flame-retardant foam sandwich panels instead of non-combustible sandwich panels. The formation of sandwich panels is to add non-combustible board or foam board in the middle of two substrates which are glass fiber reinforced magnesium oxychloride cement boards.

As a further improvement and supplement of the above mentioned technical solution, this invention also includes the following additional technical features:

The formation of bonding faces of the connector and birdsmouth is as follows: firstly, make one bonding face of right-angled ladder shape and other bonding face of right-angled flat shape. Secondly attach the bonding face of right-angled flat shape to the bonding face of right-angled ladder shape, which makes the adhered bonding face as twice thick as the non-combustible sandwich panel.

The employment of right-angled ladder-shaped bonding face increases the adhesion area and thus enhances the cohesion strength. Specific bonding methods include:

If one bonding face of the birdsmouth is cut into right-angled ladder shape, the corresponding substrate of the connector should be of a right-angled flat shape and be put into the right-angled bonding face of the birdsmouth. For other three substrates of the connector, the one(s) stretching into the birdsmouth should be cut into right-angled ladder shape, which can be one stretching into the birdsmouth and the rest two adhering directly to the outer surface of the main air duct; or two substracts stretching into the birdsmouth and the one left adhering directly to the outer surface of the main air duct; or all the three substrates stretching into the birdsmouth.

If two faces of the birdsmouth are cut into right-angled ladder shape (these two faces could be adjacent or opposite), the corresponding bonding faces of the connector in the branch air duct should be of a right-angled flat shape. For the other two substrates of the connector, the one(s) stretching into the birdsmouth should be cut into right-angled ladder shape, which can be one stretching into the birdsmouth and the one left adhering directly to the outer surface of the main air duct; or all the two substrates stretching into the birdsmouth. It is better to have two opposite faces of the birdsmouth and the two faces of the connector which are adhered to the right-angled flat faces of the birdsmouth cut into right-angled ladder shape

If three faces of the birdsmouth are cut into right-angled ladder shape, the three corresponding bonding faces of the connector in the branch air duct should be of a right-angled flat shape. The remaining one side if stretching into the birdsmouth should be cut into right-angled ladder shape.

If four faces of the birdsmouth are all cut into right-angled ladder shape, all faces of branch duct connecting area should be of a right-angled flat shape, which is the best bonding mode among all.

Cut all the four bonding faces of the connector into right-angled ladder shape and put all the bonding faces of the birdsmouth inside the right-angled ladder-shaped faces.

The operation to connect branch duct to the main air duct can be done at the construction site, which saves the space and expense for the storage and transportation.

The procedure to make bonding faces of right-angled ladder-shaped is as follows: Cut a vertical seam in one substrate of the non-combustible sandwich panel, and a horizontal seam in the other one substrate of the same. A depth of the vertical seam is the combined thickness of one substrate and the non-combustible material layer of the non-combustible sandwich panel. A distance from the seam to the end of the non-combustible sandwich panel is the thickness of the non-combustible sandwich panel. The length of the horizontal seam mentioned above is a distance from the vertical seam to an end of the non-combustible sandwich panel. The birdsmouth and the connector are joined together by caking agent which is applied on the right-angled ladder-shaped faces. Similarly, the right-angle ladder-shaped bonding faces can also be cut at the installation site. It's better to apply caking agent to the right-angled ladder-shaped faces because it is more likely to flow and also can play an equivalent effect of adhesion on the right-angled flat surface. The application of caking agent on the right-angled ladder-shaped faces should be even, plump and of an appropriate amount of caking agent.

An underside of the mentioned birdsmouth is located in the middle of one side panel of the main air duct or in the lower panel of the main air duct.

If the underside of the mentioned birdsmouth is located in the middle of one substrate of the main air duct, the mentioned birdsmouth could be located in the middle of the substrate. This is under the situation that the diameter of the branch duct is smaller than the diameter of the main duct. When the underside of the mentioned birdsmouth is located in the bottom surface of the main air duct, there are two possibilities: only one side is located on the main duct substrate adjacent to the birdsmouth; or two opposite faces are located on the main duct substrate adjacent to the birdsmouth, which suits the situation that the diameter of the branch duct equals to the diameter of the main air duct. In this process, we can cut according to actual needs. For example, if the lower (upper) panel of the branch duct parallels to the lower (upper) panel of the main duct after bonding, we can cut the two corresponding panels into irregular shapes offsetting each other, that is to form on the surface of the birdsmouth a outward of a distance of “a”, and cut on the correspondent surface of the branch duct a inward of the same distance “a”. The outward and inward offset one another and are conducive to enhancing the connection of the main air duct and branch air duct.

The air ducts produced by using the above-mentioned production process includes the main air duct is located the birdsmouth whose dimension is matching to the diameter of the branch air duct, at the end of the branch air duct is formed the connector, the birdsmouth and connector are glued together, non-combustible sandwich panels are used to assemble the said main air duct and branch air duct which are rectangular cross-sectional, the adhered bonding faces between two adjacent non-combustible sandwich panels are of the right-angled ladder shape and the right-angled flat shape which match to each other and a thickness of the bonding area is as twice thickness of the non-combustible sandwich panel.

The underside of the said birdsmouth is located in the middle of one side panel of the main air duct or in the lower panel of the main air duct; the birdsmouth is outward if the underside of the birdsmouth is on the lower panel of the main air duct. When the underside is located in the bottom face of the main air duct, the underside of the birdsmouth protrudes, while if the bonding faces of the birdsmouth are all located on the upper face of the main air duct, the bonding faces must protrude as well. The connecting mode in this case is the offset connection which enhances the connection between the main and the branch air ducts.

The corresponding bonding faces of the connector and the birdsmouth as described are the right-angled ladder-shaped bonding faces and the right-angle flat bonding faces respectively. The right-angle flat bonding face is placed into the right-angled ladder-shaped bonding face, which create a bonding area of twice thickness of the non-combustible sandwich panel.

A deflector plate is installed in a joint of the described connector and birdsmouth. Setting deflector plate at the connection of the main air duct and the branch air duct is included in the third step of the fabrication process. The deflector plate should be installed at the inner corner of the connection of the main and branch air ducts, namely in the downwind direction. Specific processes include cutting the corresponding position of the branch duct so as to form a corresponding opening for the deflector plate of its shape between the main air duct and the branch duct, and then bonding the deflector plate to the opening. The deflector plate helps to reduce the air flow resistance force at the connection of the main and the branch duct and ensure adequate amount of air entering into the branch duct.

The beneficial effects of the invention are: 1. Branch ducts and main ducts can be produced according to the invention and the position of the branch duct relative to the main duct can be adjusted according to the actual needs of installation and construction requirements, which makes the position of the branch coduct complied with the pre-installation position; 2. The main air ducts and branch air ducts can be assembled and connected at the construction site, which saves the space and expense of the storage and transportation; 3. The connection flange in the existing technology is not needed anymore. The connector and the birdsmouth which are made of the air duct itself are used to connect the main air duct and the branch air duct; 4. Having optimized the process and reduced the production hours and material consumption according to material characteristics.

### BRIEF DESCRIPTION OF THE DRAWINGS

FIG. 1—the flow chart of the invention

FIG. 2—Schematic diagram of the Air Duct Invented

FIG. 3—Cross-sectional View of the Main Air Duct and the Branch Air Duct

FIG. 4-FIG. 6, FIG. 8, FIG. 9, FIG. 12 and FIG. 17—Cross-sectional View of Various Air Ducts Invented

FIG. 7—Post View of FIG. 6

FIG. 10 and FIG. 11—two kinds of decomposition-type of FIG. 9 from another angle

FIG. 18—Schematic diagram of the upper/lower panel of the main air duct in FIG. 14-FIG. 17

FIG. 19—Schematic diagram of the branch air duct in FIG. 14-FIG. 16

FIG. 20—Schematic diagram of the branch air duct in FIG. 17

FIG. 21 to FIG. 15 or FIG. 16 for three-dimensional structure diagram:

FIG. 22—Three-dimensional schematic view of FIG. 17

### DETAILED DESCRIPTION OF THE INVENTION

The following gives detailed description of the invention by using drawings and specific implementation methods.

### Example 1

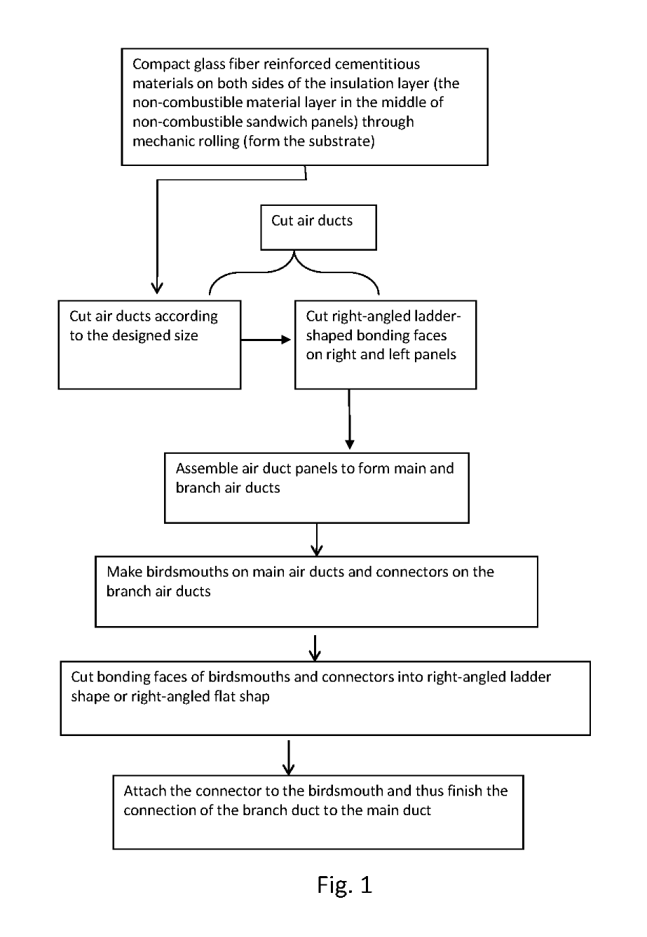

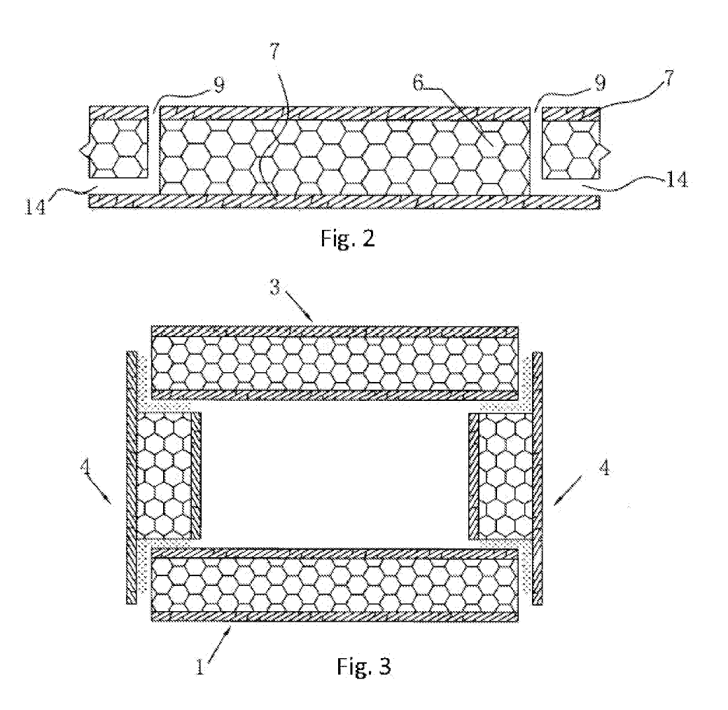

A fabrication process to connect branch ventilating ducts to main ventilating ducts, as shown in FIG. 1 (The steps within the broken lien frame don't apply to this example), includes following steps: Firstly, to fabricate air duct panels (namely non-combustible sandwich panels). Its production process is as follows: place an inorganic layer 7 (namely the substrate of the non-combustible sandwich panel) in the mould by mechanical rolling; put the selected insulation layer 6 (the non-combustible material layer in the middle of non-combustible sandwich panels) on top of the inorganic layer 7; place an inorganic layer 7 on top of the insulation layer 6; as the inorganic layer 7 solidifies here forms the non-combustible sandwich air duct panel (as shown in FIG. 2 and FIG. 3); then cut air duct panel and form the main air duct panel and the branch air duct panel through following procedures: firstly, cut air duct panels according to the designed size; Secondly, cut the two sides of the left and right panels 4 of the main air duct 11 which are in connection to the upper panel3 and the lower panel 1 into right-angled ladder shape, and also cut the two sides of the left and right panels 4 of the branch air duct 22 which are connected to the upper panel3 and the lower panel 1 into right-angled ladder shape; the right-angled ladder-shaped bonding face must connect with the right-angled flat bonding face, which forms a bonding area as twice thick as the non-combustible sandwich air duct panel; assemble the cut air duct panels into main air duct and branch air duct of rectangular cross-sections; thirdly, open on the main air duct the birdsmouth 10 matching to the diameter of the branch air duct; fourthly, bond the connector21 on the branch air duct 22 to the birdsmouth 10.

The procedures to make right-angled ladder-shaped bonding face are as follows: Cut vertical seam9 in one substrate of the non-combustible sandwich panel, and horizontal seam14 in the other. The depth of the vertical seam9 is the combined thickness of one substrate and the non-combustible material layer of the non-combustible sandwich panel. The distance from the seam to the end of the non-combustible sandwich panel is the thickness of the non-combustible sandwich panel. The length of horizontal seam14 mentioned above is the distance from the vertical seam9 to the end of the non-combustible sandwich panel.

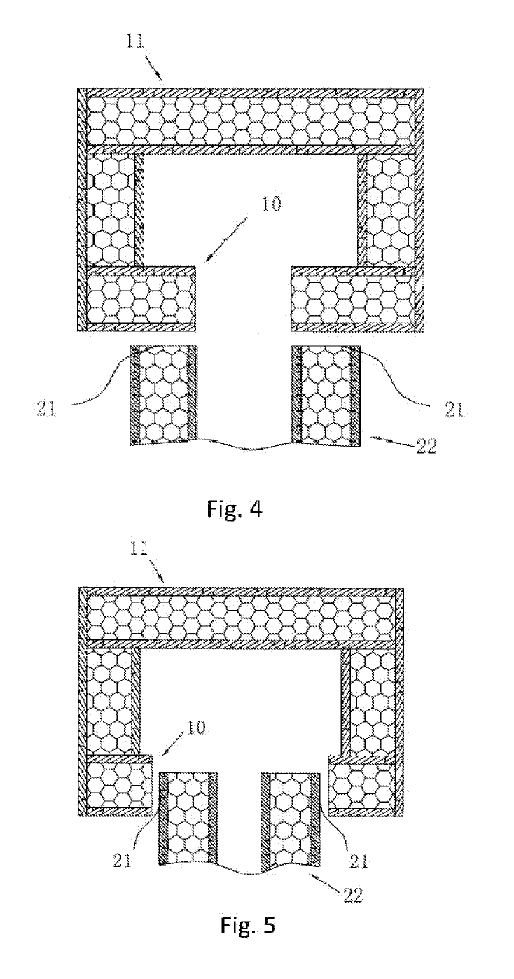

In this example, the birdsmouth10 is located in the middle of one side plate of the main air duct11. The bonding faces of the birdsmouth are all of the right-angled ladder shape. Four bonding faces of the connector21 are all of the right-angled flat shape. The connector21 of the branch air duct22 is directly connected to the outer surface of the main air duct11, as shown in FIG. 4.

All cutting works regarding to air ducts, right-angled latter-shaped bonding faces and birdsmouths can be conducted at the construction site according to the designed size.

At the site of installation, we can open birdsmouths at any position of the main air duct side paltes according to the installation requirements. The size of the birdsmouth should match to the dimension of the branch air duct.

To bond the air duct panels, we should apply caking agent to the surface of the right-angled ladder-shaped bonding faces evenly, fully and to an appropriate amount. Beside we should bind tightly the bonded panels with strapping tapes. The distance between each group of strapping tapes depends to the actual situation. Strapping tapes and the four angles of the air duct must be protected by 90° hard angle plate. If necessary, the inner corner of the air duct must be supported by temporary bracing pieces to ensure a rectangular duct. As all air duct panels being well positioned and fixed, we should remove the caking agent squeezed out and fill gaps. When the caking agent becomes solidified, remove strapping tapes and temporary bracing pieces.

The caking agent used here is composed of two parts, the powder A and the liquid B which is made from tablets (granule). For transportation convenience, the liquid B is prepared on site in accordance with the instructions. Group A and group B are mixed at a weight ratio of 10.0:7.0. The mixture is poured into the electric mixer for complete mixing. The adhesive after stirring should preferably have a slight of liquidity. In addition, the adhesive should be used timely. If the adhesive is found to have no liquidity, it can not be used any more even though liquid is added to dilute it.

### Example 2

A fabrication process to connect branch ventilating ducts to main ventilating ducts, as shown in FIG. 5. In this example, the birdsmouth10 is located in the middle of one side plate of the main air duct11. The bonding faces of the birdsmouth are all of the right-angled flat shape. Four bonding faces of the connector21 are all of the right-angled flat shape as well. The connector21 are completed placed in the birdsmouth10 for the connection. Other processes are the same as Example 1.

### Example 3

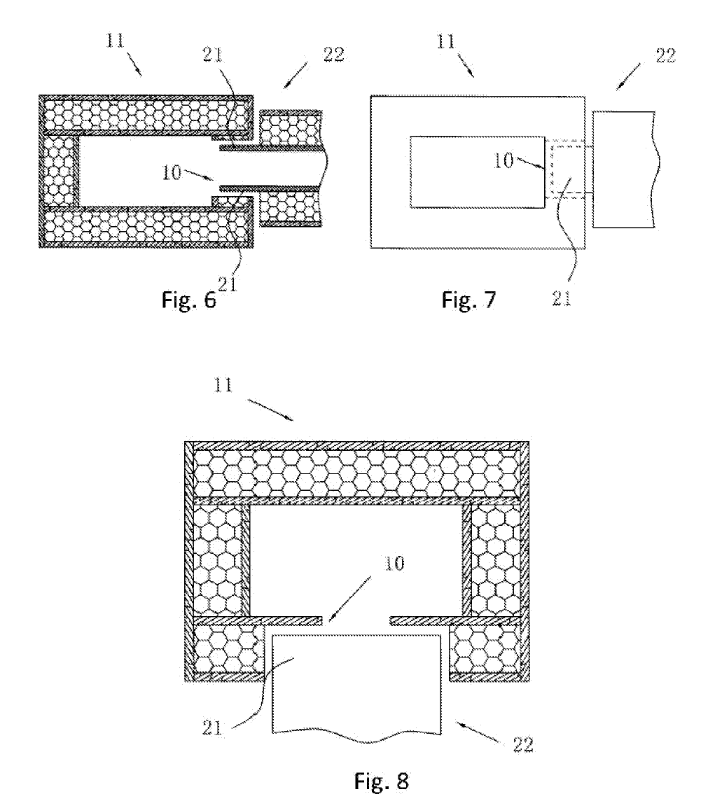

A fabrication process to connect branch ventilating ducts to main ventilating ducts, as shown in FIG. 1 (exclusive of the steps within the broken lien frame), FIG. 6 and FIG. 7. In this example, the birdsmouth10 is located in the middle of one side plate of the main air duct11. The bonding faces of the birdsmouth are all of the right-angled flat shape. Four bonding faces of the connector21 are all of the right-angled ladder shape. The right-angled flat bonding faces are placed in the right-angled ladder-shaped bond faces for connection. The said adhesive is applied to the said right-angled ladder-shaped bonding faces. Other processes are the same as Example 1.

### Example 4

A fabrication process to connect branch ventilating ducts to main ventilating ducts, as shown in FIG. 1 and FIG. 8. In this example, the birdsmouth10 is located in the middle of one side plate of the main air duct11. The bonding faces of the birdsmouth are all of the right-angled ladder shape. The bonding faces of the connector21 are all of the right-angled flat shape. The right-angled flat bonding faces are placed in the right-angled ladder-shaped bond faces for connection. Other processes are the same as Example 1.

### Example 5

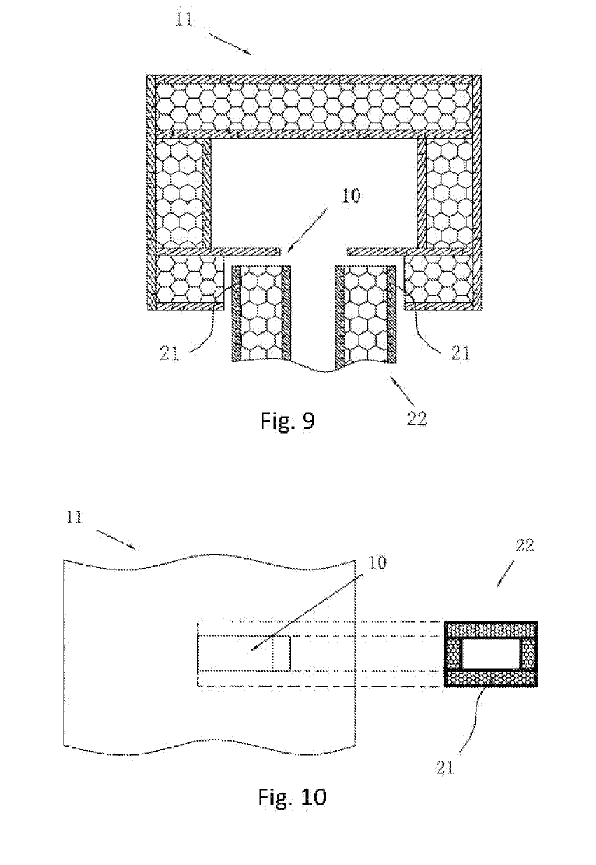

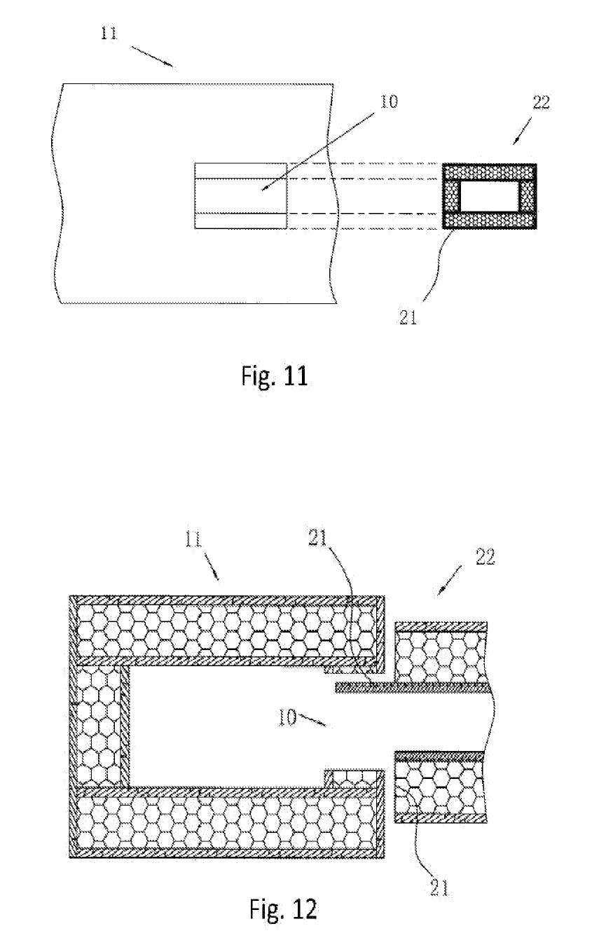

A fabrication process to connect branch ventilating ducts to main ventilating ducts and ventilation ducts invented. In this example, the birdsmouth10 is located in the middle of one side plate of the main air duct11. Two opposite faces of the birdsmouth are cut into right-angled ladder shape. The two right-angled flat bonding faces of the connector 21 are placed into the right-angled ladder-shaped bonding faces fro connection. The other two right-angled flat bonding faces of the connector 21 are attached directly to the outer surface of the main air duct11. See FIGS. 1, 9, 10 and 11. The FIG. 10 shows that the right and left panels of the branch air duct are placed into the right-angled ladder-shaped bonding faces on the right and left side of the birdsmouth 10. The other two side plates are directly attached to the outer surface of the main air duct11. The FIG. 11 shows that the upper and lower panels of the branch air duct are placed into the right-angled ladder-shaped bonding faces on the upper and lower side of the birdsmouth 10. The other two side plates are directly attached to the outer surface of the main air duct11. Other processes are the same as Example 1.

### Example 6

A fabrication process to connect branch ventilating ducts to main ventilating ducts and ventilation ducts invented. In this example, the birdsmouth10 is located in the middle of one side plate of the main air duct11. The four bonding faces of the birdsmouth10 are all of the right-angled flat shape. Place the upper plate which is cut into right-angled ladder shap of the connector 21 into the birdsmouth 10. Other bonding faces of the connector 21 should be of right-angled flat shape. The lower panel of the connector 21 is directly attached to the outer surface of the main air duct11, as shown in FIG. 1 and FIG. 2. Other processes are the same as Example 1.

### Example 7

A fabrication process to connect branch ventilating ducts to main ventilating ducts and ventilation ducts invented. In this example, the birdsmouth10 is located in the middle of one side plate of the main air duct11. Two opposite bonding faces of the birdsmouth10 are cut into the right-angled ladder shape and the other two faces are of the right-angled flat shape. Place the connector 21 into the birdsmouth 10. The bonding faces of the connector 21 corresponding to the right-angled ladder-shaped bonding faces and the right-angled flat bonding faces of the birdsmouth are the right-angled flat bonding faces and the right-angled ladder-shaped bonding faces respectively, as shown in FIG. 1 and FIG. 13. Other processes are the same as Example 1.

### Example 8

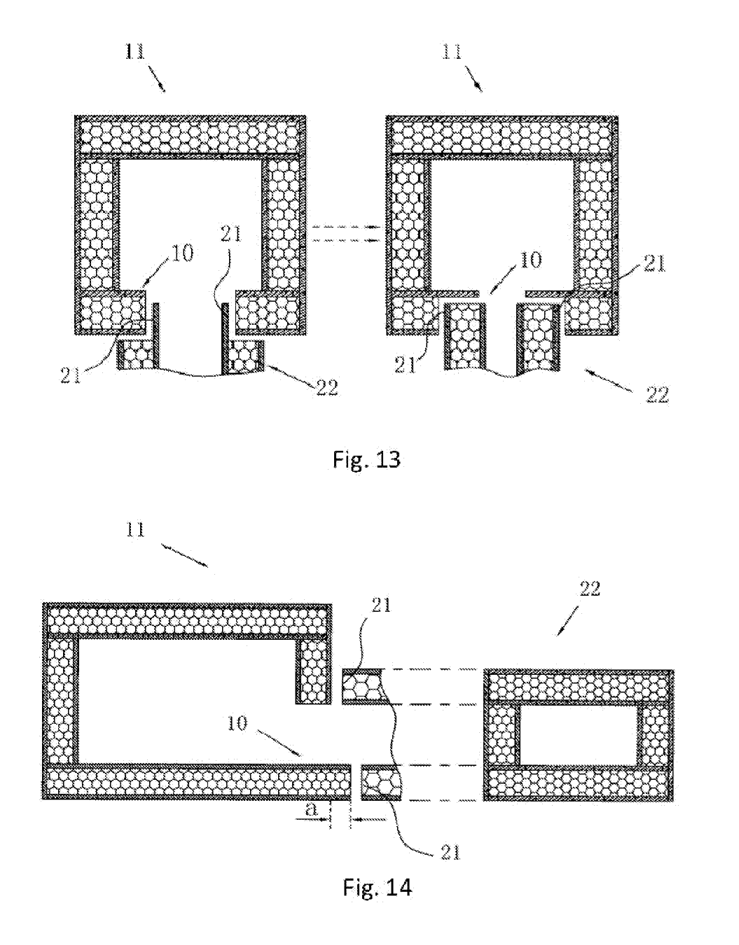

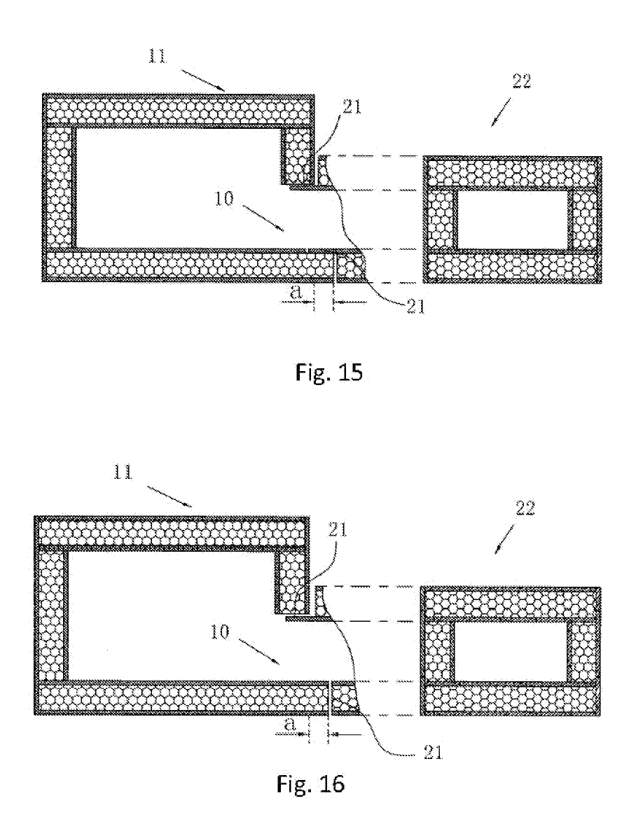

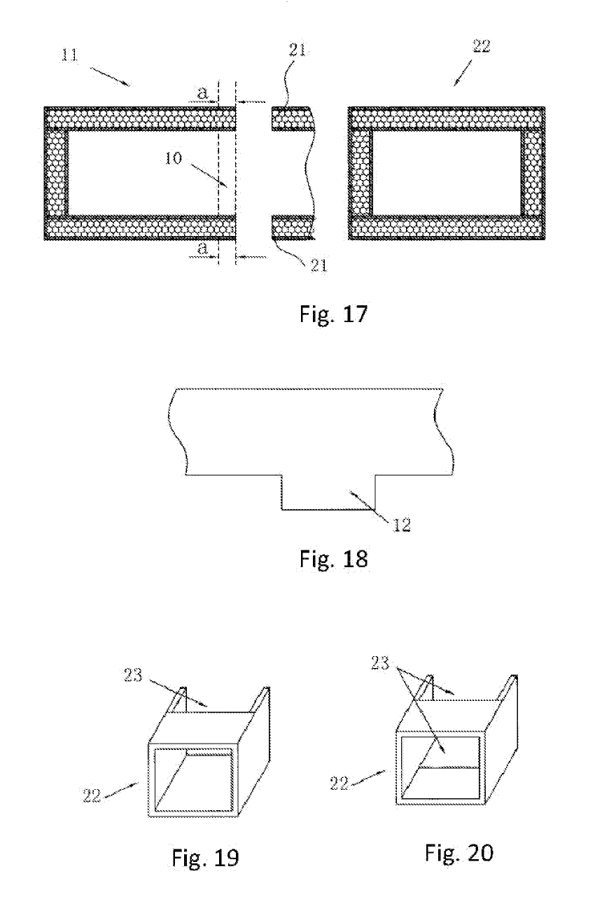

A fabrication process to connect branch ventilating ducts to main ventilating ducts and ventilation ducts invented, as shown in FIG. 1, FIG. 14-16 and FIG. 21. If the underside of the birdsmouth 10 is located in the bottom panel of the main air duct 11, the birdsmouth is outward, that is the lower panel1 of the main duct11 extends for a distance of “a” at the joint to the lower panel1 of the branch duct 22 and forms a convex 12 (as shown in FIG. 18). Correspondingly the lower panel1 of the connector21 should have a concave23 of the same distance “a” (as shown in FIG. 19 and FIG. 20). Place deflector plate8 in air duct in a downwind direction. The deflector plate and the main air duct should form a 45° angle. Under above-mentioned condition, there are three favorable ways to connect the main air duct11 and the branch air duct22. The first one as shown in FIG. 14 is to attach the connector 21 directly to the outer surface of the main air duct11. The second one as shown in FIG. 15 is to cut the upper bonding face of the connector 21 into right-angled ladder shape and place it in the birdsmouth10 whose four faces are all of the right-angled flat shape. The third one as shown in FIG. 16 is to cut the upper and lower bonding faces of the connector 21 into right-angled ladder shape and place them in the birdsmouth10 whose four faces are all of the right-angled flat shape. Other processes are the same as above-mentioned examples.

### Example 9

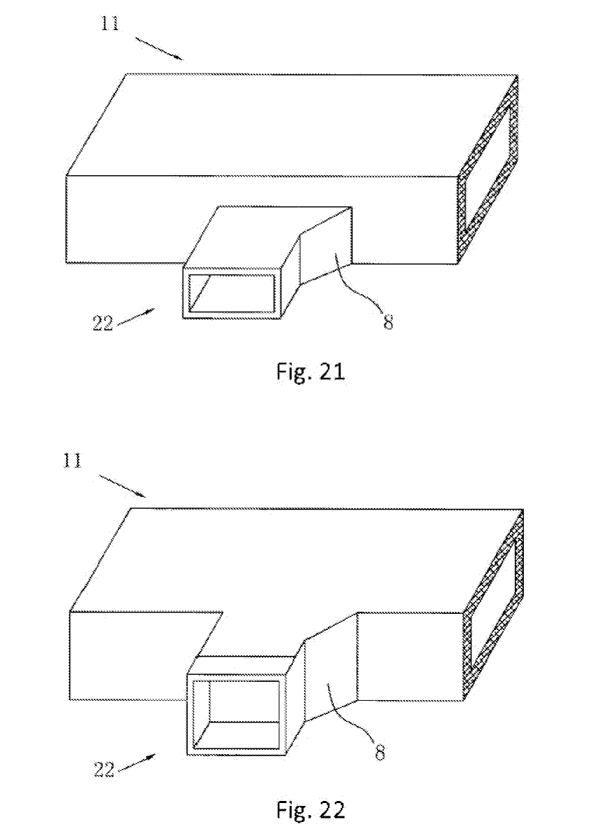

A fabrication process to connect branch ventilating ducts to main ventilating ducts and ventilation ducts invented, as shown in FIG. 1, FIG. 17 and FIG. 22. If the underside of the birdsmouth 10 is located in the bottom panel of the main air duct 11 and the upper bonding face is located in the lower panel of the main air duct, the underside and the upper bonding face the birdsmouth is outward, that is the upper panel1 of the main duct11 extends for a distance of “a” at the joint to the upper panel1 of the branch duct 22 and forms a convex 12 and the lower panel1 of the main duct11 extends for a distance of “a” at the joint to the lower panel1 of the branch duct 22 and forms a convex 12, as shown in FIG. 18. Correspondingly concave 23 of the same distance “a” should be formed at the corresponding position of the branch air duct22 (as show in 20). Place deflector plate8 in air duct in a downwind direction. The deflector plate and the main air duct should form a 45° angle. Other processes are the same as Example 8.

What is claimed is:

1. A fabrication process to connect branch ventilating ducts to main ventilating ducts comprising:
Step 1, use non-combustible sandwich panels which are consisted by substrates on both sides and non-combustible material in middle to form a main air duct and a branch duct, both have rectangular cross-section;
Step 2, open on side panels of the main air duct birdsmouths (10) corresponding to a diameter of the branch air duct;
Step 3, attach a connector (21) on the branch duct to the birdsmouth (10).

2. The fabrication process to connect branch ventilating ducts to main ventilating ducts as described in claim 1, wherein the formation of bonding faces of the connector (21) and the birdsmouth (10) as follows: firstly, make one bonding face of right-angled ladder shape and other bonding face of right-angled flat shape, secondly attach the bonding face of right-angled flat shape to the bonding face of right-angled ladder shape, which makes the adhered bonding face as twice thick as the non-combustible sandwich panel.

3. The fabrication process to connect branch ventilating ducts to main ventilating ducts as described in claim 2, wherein the procedure to make the bonding faces of right-angled ladder-shaped is as follows: Cut a vertical seam (9) in one substrate of the non-combustible sandwich panel, and a horizontal seam (14) in the other one substrate of the same, a depth of the vertical seam (9) is the combined thickness of one substrate and the non-combustible material layer of the non-combustible sandwich panel, a distance from the seam to the end of the non-combustible sandwich panel is the thickness of the non-combustible sandwich panel, the length of the horizontal seam (14) is a distance from the vertical seam (9) to an end of the non-combustible sandwich panel, the birdsmouth (10) and the connector (21) are joined together by caking agent which is applied on the right-angled ladder-shaped faces.

4. The fabrication process to connect branch ventilating ducts to main ventilating ducts as described in claim 1, wherein an underside of the said birdsmouth (10) is located in middle of one side panel of the main air duct (11) or in the lower panel of the main air duct (11).

5. A connecting structure of a branch ventilating ducts with a main ventilating ducts, wherein in the main air duct (11) is located the birdsmouth (10) whose dimension is matching to the diameter of the branch air duct, at the end of the branch air duct (22) is formed the connector (21), the birdsmouth (10) and connector (21) are glued together, non-combustible sandwich panels are used to assemble the said main air duct (11) and branch air duct (22) which are rectangular cross-sectional, the adhered bonding faces between two adjacent non-combustible sandwich panels are of the right-angled ladder shape and the right-angled flat shape which match to each other and a thickness of the bonding area is as twice thickness of the non-combustible sandwich panel.

6. The connecting structure of claim 5, wherein the underside of the said birdsmouth (10) is located in the middle of one side panel of the main air duct (11) or in the lower panel of the main air duct (11), the birdsmouth (10) is outward if the underside of the birdsmouth (10) is on the lower panel of the main air duct (11).

7. The connecting structure of claim 6, wherein corresponding bonding faces of the connector and the birdsmouth are the right-angled ladder-shaped bonding faces and the right-angle flat bonding faces respectively, the right-angle flat bonding face is placed into the right-angled ladder-shaped bonding face, which create a bonding area of twice thickness of the non-combustible sandwich panel.

8. The connecting structure of claim 7, wherein a deflector plate is (8) installed in a joint of the said connector (21) and birdsmouth (10).
